(19) United States
(12) Patent Application Publication
(10) Pub. No.: US 2020/0385049 A1
(43) Pub. Date: Dec. 10, 2020

(54) PRODUCTION OF AN UPPER PART OF A POWER STEERING SUPPORT ELEMENT WITHOUT WELD SEAM

(71) Applicant: JTEKT EUROPE, IRIGNY (FR)

(72) Inventors: Clément THIVIN, Lyon (FR); Philippe CHAUVRAT, VILLENEUVE (FR)

(73) Assignee: JTEKT EUROPE, IRIGNY (FR)

(21) Appl. No.: 16/769,767

(22) PCT Filed: Nov. 30, 2018
(86) PCT No.: PCT/FR2018/053057

§ 371 Date: Jun. 4, 2020

(30) Foreign Application Priority Data
Dec. 4, 2017 (FR) 17/61586

(51) Int. Cl. B62D 1/16

(52) U.S. Cl. CPC B62D 1/16

(57) ABSTRACT

A part intended to be folded so as to form an upper part of a power steering support element of a vehicle, made of a flat plate including: at least one attachment area for attaching the upper part to a vehicle chassis, at least one extension area to be positioned in a plane perpendicular to the plane in which the attachment area extends, and at least one folding area.

The invention concerns the field of power steering devices for a motor vehicle and more particularly to an upper part of a support element of a steering column.

The role of a steering column of a power steering is to transmit a torque exerted by a driver on a steering wheel to a rack, in order to turn the wheels of the vehicle.

More particularly, the steering column is a set of mechanical parts arranged so as to connect the steering wheel to an assistance motor mounted on an intermediate axis.

The steering column allows the steering wheel to be adjusted in depth along a longitudinal axis of the steering column, and the steering wheel to be adjusted in height.

The steering column comprises in particular a set of two hollow coaxial tubes, the external tube and the internal tube, interlocked one inside the other so that the external tube at least partially covers the internal tube. The upper tube and the internal tube slide one into the other so that a total length of the tubes along a longitudinal axis, that is to say along the longitudinal axis of the steering column, varies between a maximum adjustment length and minimum adjustment length. The two adjustment lengths allow the steering wheel to be adjusted in depth.

The steering column 1′ is held to a frame of the vehicle at the level of the external tube by a support element 2′, 3′ as can be seen in FIG. 1.

Generally, the support element 2′, 3′ comprises at least one fixed upper part 2′ connected to a lower part 3′ movable relative to the upper part 2.

The lower part 3′ supports the external tube 1′ and allows the steering wheel to be adjusted in depth and in height.

The manufacture of the upper part 2′ comprises:
a step of manufacturing a fixing plate including at least one substantially flat area comprising at least one through hole intended to fix the upper part 2′ to the frame of the vehicle;
a step of manufacturing a holding stirrup provided with a base, whose two parallel sides are extended by two perforated elongations so as to form a U;
a step of producing a weld bead in order to fix each of the sides of the base of the stirrup on the fixing plate.

The step of producing a weld bead guarantees a mechanical strength and a rigidity of the holding stirrup on the fixing plate with respect to the forces exerted on the upper part under normal conditions and in a crash situation.

The production of a weld bead causes a deformation of the elongations of the holding stirrup so that the elongations can no longer be parallel and the perforations can no longer be aligned. Thus, it becomes difficult, even impossible in some cases, to fix the lower part 3′ to the upper part 2′.

Furthermore, the step of producing a weld bead is one of the longest steps to perform on a production line.

The invention aims to remedy all or part of the aforementioned drawbacks by proposing a part, intended to be folded so as to form an upper part of a support element of a power steering of a vehicle, consisting of a flat plate comprising:
at least one fixing area intended to fix the upper part to a frame of the vehicle,
at least one elongation area intended to be positioned in a plane perpendicular to the plane in which the fixing area extends,
and at least one folding area.

Thus, the part intended to be folded so as to form an upper part of a support element for a power steering of a vehicle, comprises all of the areas necessary for, on the one hand, fixing the part to the frame of the vehicle, via the fixing area, and on the other hand, retaining a movable lower part.

Before folding, the part is substantially flat, that is to say that all the areas of the part are substantially in the same plane which will be subsequently defined as the plane of the fixing area. In one embodiment, the part may have deformations of the boss type.

Furthermore, the part is formed in a single wall which can be made of metal.

Each of the areas of the part is arranged so as to be at least partially in contact with an adjacent area.

According to a characteristic of the invention, the part comprises a plurality of fixing areas.

According to a characteristic of the invention, the part comprises two elongation areas.

According to a characteristic of the invention, the two elongation areas are disposed on either side of the fixing area.

According to a characteristic of the invention, the part comprises a plurality of folding areas.

According to a characteristic of the invention, the at least one fixing area comprises at least one through-orifice.

Thus, the fixing area is fixed to the frame of the vehicle by inserting an element, of the screw type, in the through-orifice.

According to a characteristic of the invention, the at least one fixing area comprises a plurality of through-orifices.

According to a characteristic of the invention, the at least one fixing area comprises a plurality of through-orifices.

According to a characteristic of the invention, the at least one fixing area has a substantially rectangular shape.

According to a characteristic of the invention, the at least one elongation area comprises at least one through orifice.

Thus, the elongation area can retain the lower part by inserting a rod into the through-orifice.

According to a characteristic of the invention, the at least one through-orifice of the elongation area has an oblong shape or a round shape

Thus, the position of the lower part can vary relative to the position of the upper element in order to allow adjustment of the height of the steering wheel.

According to a characteristic of the invention, the at least one folding area has the shape of a substantially rectilinear straight line.

Thus it is easy to fold a first area relative to a second area following the folding area.

According to a characteristic of the invention, the at least one folding area is positioned on an edge of the at least one fixing area.

Thus the elongation area can be folded relative to the fixing area so as to be positioned at an angle of 90° for example.

According to a characteristic of the invention, the part also comprises at least one holding area.

The holding area is intended to hold the position of the elongation area relative to the fixing area after folding of the part.

Thus, the holding area guarantees a mechanical strength and a rigidity of the elongation area relative to the fixing area with respect to the forces exerted on the upper part under normal conditions and in a crash situation.

According to a characteristic of the invention, the part comprises a plurality of holding areas.

According to a characteristic of the invention, the at least one holding area is intended to be positioned in contact with the fixing area after folding of the part.

According to a characteristic of the invention, the at least one holding area has an area of less than 5 cm², preferably less than 1 cm².

Thus the holding area can be fixed by means of resistance weld, a weld bead, a rivet, or a clinching.

According to a characteristic of the invention, the at least one holding area has a substantially rectangular shape.

According to a characteristic of the invention, a folding area is positioned on an edge of the at least one holding area.

Thus the holding area allows holding the elongation area in a plane perpendicular to the plane of the fixing area.

The invention also relates to a method for manufacturing an upper part of a support element of a power steering comprising:
a step of cutting a part according to any one of claims 1 to 10 in a plate;
a step of folding the part at the level of the at least one folding area.

The step of cutting the part in a plate, which can be a metal sheet, is carried out using a laser, a jet of water, or air, submerged plasma, HD plasma. The cutting step can also be carried out by detailing, by the use of a hollow punch or by a cutter saw.

According to a characteristic of the invention, the folding step consists in forming an angle comprised between 0° and 180° between two planes at the level of a folding area.

Preferably, the folding step consists in forming an angle substantially equal to 90° between two planes at the level of a folding area.

Thus, the elongation area is positioned in a plane perpendicular to the plane of the fixing area.

According to a characteristic of the invention, the manufacturing method comprises a step of holding the at least one holding area on the at least one fixing area.

Thus the holding area is fixed on the fixing area.

According to a characteristic of the invention, the holding step can be carried out by a means among: a resistance weld, a weld bead, a rivet, a clinching, a crimping, a braze, a braze welded joint, a laser weld.

Thus the holding step is quickly carried out on an assembly line.

The invention will be better understood from the following description, which relates to several embodiments according to the present invention, given by way of non-limiting examples and explained with reference to the appended schematic drawings, in which:

FIG. 1 is a representation of a support element and a steering column of the state of the art;

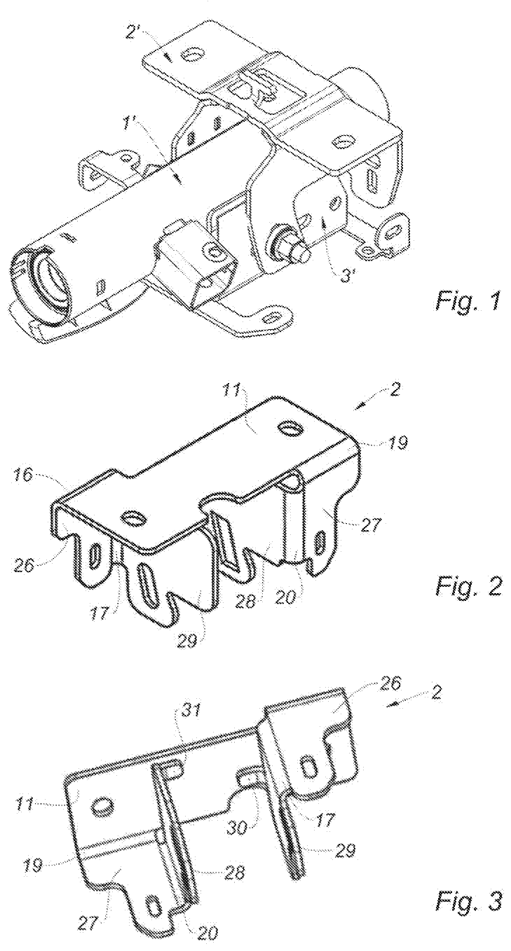

FIG. 2 is a perspective view of a support element according to a first embodiment of the invention,

FIG. 3 is a bottom perspective view of the support element according to the first embodiment of the invention,

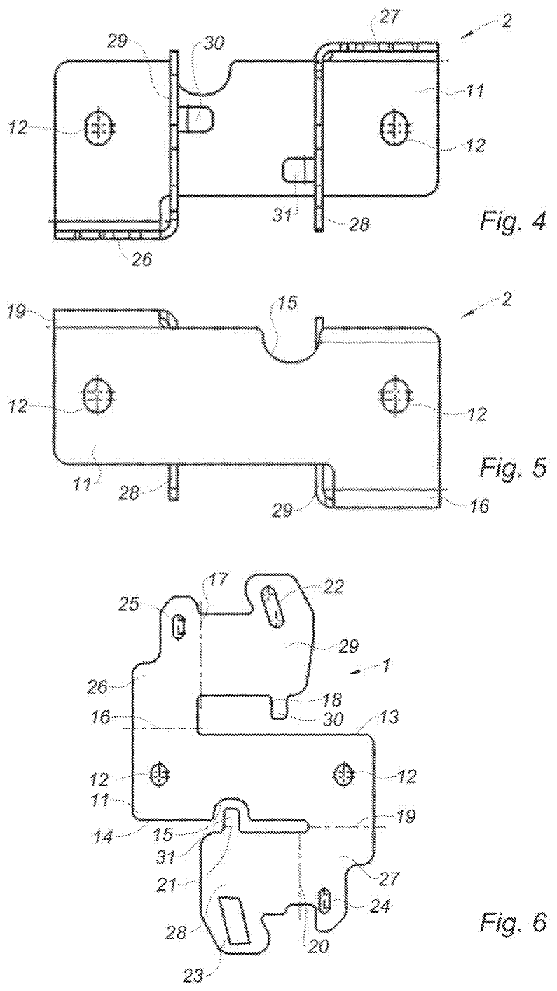

FIG. 4 is a bottom view of the support element according to the first embodiment of the invention,

FIG. 5 is a top view of the support element according to the first embodiment of the invention,

FIG. 6 is a representation of a part intended to form, after a folding step, the support element according to the first embodiment of the invention,

FIG. 7 is a perspective view of a support element according to a second embodiment of the invention,

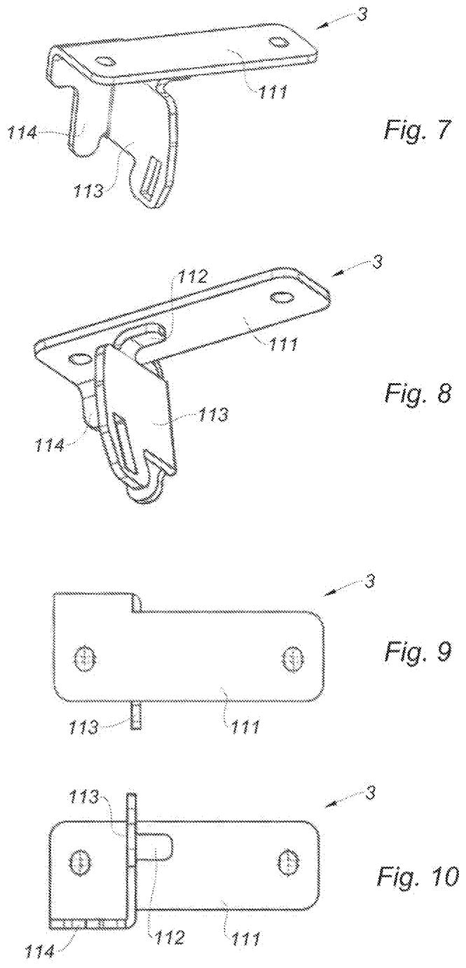

FIG. 8 is a bottom perspective view of the support element according to the second embodiment of the invention,

FIG. 9 is a top view of the support element according to the second embodiment of the invention,

FIG. 10 is a bottom view of the support element according to the second embodiment of the invention,

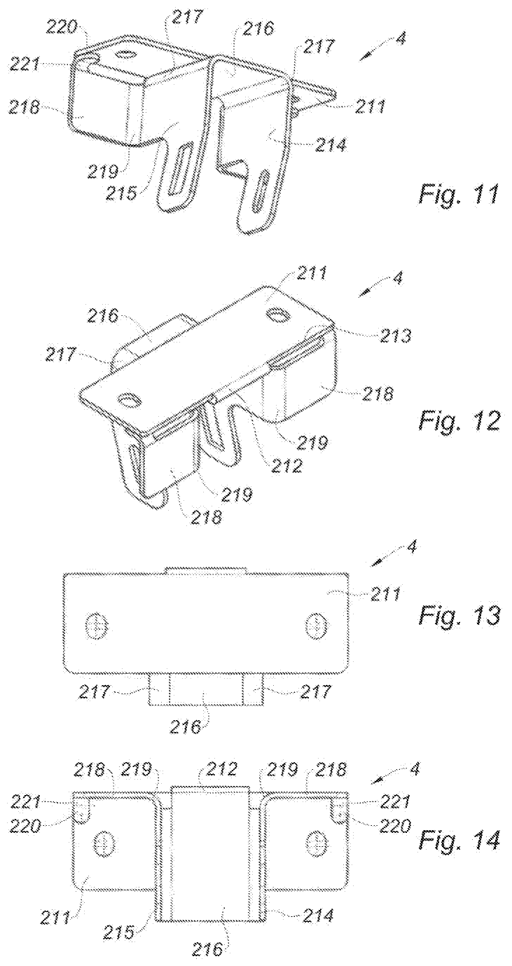

FIG. 11 is a perspective view of a support element according to a third embodiment of the invention,

FIG. 12 is a perspective view of the support element according to the third embodiment of the invention,

FIG. 13 is a top view of the support element according to the third embodiment of the invention,

FIG. 14 is a bottom view of the support element according to the third embodiment of the invention,

FIG. 6 represents a part 1 according to a first embodiment of the invention produced after a cutting step and before a folding step. The part 1 is flat and comprises a substantially rectangular fixing area 11, that is to say with a first long side 13 parallel to a second long side 14 and two short sides parallel to each other. The fixing area 11 comprises two through holes 12 positioned at each end of the fixing area 11 in the direction of elongation of the fixing area 11.

The part 1 further comprises a first elongation area 29 and a second elongation area 28 each including an oblong through orifice 22, 23. The two elongation areas 28, 29 have a substantially identical shape.

The first elongation area 29 is separated from a first holding area 30 by a first folding area 18. The first holding area 30 has a substantially rectangular shape of 1 cm² and is positioned facing the first long side 13 of the fixing area 11 without, however, being in contact with it.

The first elongation area 29 is also separated from a first edge area 26 by a second folding area 17. The first edge area 26 has a substantially elongated shape and includes a through orifice 25.

The first edge area 26 is separated from the fixing area 11 by a third folding area 16 so that the third folding area 16 is perpendicular to the second folding area 17. Thus, the fixing area 11 and the first elongation area 29 are positioned on two perpendicular sides of the first edge area 26.

The second elongation area 28 is separated from a second holding area 31 by a fourth folding area 21. The second holding area 31 has a substantially rectangular shape of 1 cm² and is positioned facing the second long side 14 of the fixing area 11 without, however, being in contact with it. For this, the fixing area 11 comprises a recess 15 on the second long side 14 of a shape complementary to the shape of the second holding area 31. Thus, the fixing area 11 is positioned between the two elongation areas 28, 29.

The second elongation area 28 is also separated from a second edge area 27 by a fifth folding area 20. The second edge area 27 has a substantially triangular shape and includes a through orifice 24.

The second edge area 27 is separated from the fixing area 11 by a sixth folding area 19 so that the sixth folding area 19 is perpendicular to the fifth folding area 20. Thus, the fixing area 11 and the second elongation area 28 are positioned on two perpendicular sides of the second edge area 27.

During a folding step, the part 1 is shaped in order to create an upper part 2 of a support element for a power steering.

The folding step consists in forming an angle of 90° at the level of the folding areas 16, 17, 18, 19, 20, 21.

So that when the part 1 is folded at the level of the third folding area 16, the first edge area 26 extends along the first long side 13 of the fixing area 11 in a plane perpendicular to the fixing area 11.

When the part 1 is folded at the level of the second folding area 17, the first elongation area 29 is in a plane perpendicular to the first edge area 26 and perpendicular to the fixing area 11. The elongation plane of the first elongation area 29 transversely cuts the elongation plane of the fixing area 11 and the elongation plane of the first edge area 26.

The first holding area 30 is positioned in the elongation plane of the fixing area 11 and in contact with the latter by folding the part 1 at the level of the first folding area 18.

In the same way, when the part 1 is folded at the level of the sixth folding area 19, the second edge area 27 extends along the second long side 14 of the fixing area 11 in a plane perpendicular to the fixing area 11.

When the part 1 is folded at the level of the fifth folding area 20, the second elongation area 28 is in a plane perpendicular to the second edge area 27 and perpendicular to the fixing area 11. The elongation plane of the second elongation area 28 transversely cuts the elongation plane of the fixing area 11 and the elongation plane of the second edge area 27.

The second holding area 31 is positioned in the elongation plane of the fixing area 11 and in contact with the latter by folding the part 1 at the level of the fourth folding area 21.

Finally, a holding step is carried out during which the first 30 and the second 31 holding area are fixed on the fixing area 11 by positioning a clamp in order to produce a resistance weld.

Thus, the initially flat part 1 forms the upper part 2 of the support element, as can be seen in FIGS. 2, 3, 4 and 5, without requiring the production of a weld bead.

FIGS. 7, 8, 9 and 10 represent a second embodiment of an upper part 3 of a support element. The second embodiment of the upper part 3 uses a part which is substantially identical to the part 1 of the first embodiment in which the second elongation area 28, the second holding area 31 and the second edge area 27 have been eliminated.

Thus, the upper part 3 according to the second embodiment includes a single fixing area 111, a single holding area 112, a single elongation area 113 and a single edge area 114.

FIGS. 11, 12, 13 and 14 represent a third embodiment of an upper part 4 of a support element. In this embodiment, a substantially rectangular fixing area 211 includes a single folding area 212 positioned at the center of a first long side 213 of the fixing area 211. A first elongation area 214 and a second elongation area 215 are each connected to the same central area 216 by a folding area 217.

Each of the elongation areas 214, 215 is connected to an edge area 218 by a folding area 219.

Each edge area 218 is connected to a holding area 220 by a folding area 221.

So that, the two holding areas 220 are in the elongation plane of the fixing area 211.

The upper part 2, 3, 4 of a support element according to any one of the previously described embodiments is provided to be fixed to a frame of a motor vehicle by means of an elongation, of the screw type, inserted in the through holes 12 of the fixing plate 11,111, 211.

Furthermore, a lower part of the support element is hooked to the upper part 2, 3, 4 by the introduction of an axis into the oblong holes 23, 22 of the elongation areas 29, 28, 113, 215, 214.

Finally, the through holes 24, 25 present on the edge areas 26, 27 of the upper part 2 of the support element is used to fix a spring allowing to hold a steering column in a so-called «high» position, when an adjustment of the latter is in progress by the driver.

Of course, the invention is not limited to the embodiments described and represented in the appended figures. Modifications remain possible, in particular from the point of view of the constitution of the various elements or by substitution of technical equivalents, without thereby departing from the field of protection of the invention.

1. A part, intended to be folded so as to form an upper part of a support element of a power steering of a vehicle, constituted by a flat plate comprising:
at least one fixing area intended to fix the upper part to a frame of the vehicle,
at least one elongation area intended to be positioned in a plane perpendicular to the plane in which the fixing area extends,
and at least one folding area area.

2. The part according to claim 1, wherein the at least one fixing area comprises at least one through hole.

3. The part according to claim 1, wherein the at least one fixing area has a substantially rectangular shape.

4. The part according to claim 1, wherein the at least one elongation area comprises at least one through hole.

5. The part according to claim 1, wherein the at least one folding area has a shape of a substantially rectilinear straight line.

6. The part according to claim 1, in which the at least one folding area is positioned on an edge of the at least one fixing area.

7. The part according to claim 1, further comprising at least one holding area.

8. The part according to claim 7, wherein the at least one holding area has an area less than 5 cm².

9. The part according to claim 7, wherein the at least one holding area has a substantially rectangular shape.

10. The part according to claim 7, wherein a folding area is positioned on an edge of the at least one holding area.

11. A method for manufacturing an upper part of a support element for a power steering system comprising:
a step of cutting a part according to claim 1 in a plate;
a step of folding the part at the level of the at least one folding area.

12. The manufacturing method according to claim 11, wherein the folding step consists in forming an angle between 0° and 180° between two planes at the level of a folding area.

13. The manufacturing method according to claim 11, comprising a step of holding the at least one holding area on the at least one fixing area.

14. The manufacturing method according to claim 13, wherein the holding step can be carried out by a means among: a resistance weld, a weld bead, a rivet, a clinch, a crimp, a braze, a braze welded joint, a laser weld.
